(19) United States
(12) Patent Application Publication
(10) Pub. No.: US 2023/0376644 A1
(43) Pub. Date: Nov. 23, 2023

(54) AIDED DESIGN METHOD FOR FEMALE UNDERWEAR

(71) Applicant: SOFT SENSE LIFE TECH PTE. LTD., SINGAPORE (SG)

(72) Inventor: KUAN-CHIEN CHOU, Taipei City (CN)

(21) Appl. No.: 18/059,455

(22) Filed: Nov. 29, 2022

(30) Foreign Application Priority Data
May 20, 2022 (CN) 202210548667.X

(51) Int. Cl. G06F 30/17

(52) U.S. Cl. CPC G06F 30/17; G06F 2111/16

(57) ABSTRACT

An aided design method for female underwear includes the following steps. The first is to receive at least one image associated with a profile of a female body. Then is to obtain a plurality of dynamic body parameters associated with the female body according to the at least one image. Then is to compare these dynamic body parameters with a content of a dynamic model database. Final is to generate an aided design parameter according to the comparison result, wherein the aided design parameter is a setting position, setting direction, shape, length, width, thickness, tensile strength, and combination thereof associated with at least one elastic support component on a female underwear.

### CROSS REFERENCE TO RELATED APPLICATIONS

This Non-provisional application claims priority under 35 U.S.C. § 119(a) on Patent Application No. 202210548667.X filed in People's Republic of China on May 20, 2022, the entire contents of which are hereby incorporated by reference.

### BACKGROUND

### 1. Technical Field

The present invention relates to an aided design method, in particular to an aided design method for female underwear.

### 2. Description of Related Art

The function of the bra is to support and hold the breast to slow down the relaxation and sagging of the breast tissue. It can also prevent the nipples from being injured by the friction of clothes during activities, such as walking, so as to promote the balanced force of the breasts in all aspects, which is an important invention for the benefit of women.

In the modern age of industrialization, there are a variety of bras or the underwear that are suitable for different body shapes and breast sizes for consumers to choose from. However, these products are not made for the specific user and are usually designed to fix and stabilize the breast by underwire or by flattening the breast so there is an unsuitable situation that causes the bra or the underwear to compress the breast or upper body (such as neck or armpit lymph nodes). Because of this, tailor-made service models have emerged on the market.

In general, a tailored bra is obtained by manually measuring various dimensions of the upper body and breasts of consumer to make a suitable bra. However, such measurement is usually done in a static state. To make a more accurate bra, it is often necessary to repeat the processes of measurement, pattern making, try-on, and reinforcement, which increases the difficulty of production and wastes a lot of time. In addition, although the various sizes of bras are in line with consumers, when consumers perform dynamic activities, such as running, there will still be various situations of insufficient support or re-derivation of friction and compression. Moreover, the compression on the body cannot be completely solved by using the underwire or by flattening the breasts.

Therefore, providing an aided design method for female underwear so that the designer or consumer of the female underwear can obtain the most suitable underwear design is one of the important subjects.

### SUMMARY OF THE INVENTION

In view of the foregoing, the object of the present invention is to provide an aided design method for female underwear, which can generate suitable bra design solution through image analysis.

To achieve the above, the aided design method for female underwear includes the following steps. The first is to receive at least one image associated with a profile of a female body. Then is to obtain a plurality of dynamic body parameters associated with the female body according to the at least one image. Then is to compare these dynamic body parameters with a content of a dynamic model database. Final is to generate an aided design parameter according to the comparison result, wherein the aided design parameter is a setting position, setting direction, shape, length, width, thickness, tensile strength, and combination thereof associated with at least one elastic support component on a female underwear.

In one embodiment, the at least one image includes a plurality of static images or at least one dynamic image.

In one embodiment, the static images include at least two images from different angles and a simulated dynamic image is generated according to the static images.

In one embodiment, the dynamic images include images of walking, running, jumping, side shifting, and combinations thereof.

In one embodiment, the profile corresponding to the female body in the at least one image includes a plurality of markers, which are respectively arranged at positions corresponding to the sternum, ribs, breasts, shoulders and/or abdomen.

In one embodiment, a subject of the at least one image is a robot device capable of simulating human motion.

In one embodiment, the dynamic model database includes a first dynamic model database and/or a second dynamic model database, wherein the first dynamic model database stores dynamic data associated with a plurality of breasts of different shapes and sizes and the second dynamic model database stores dynamic data associated with a plurality of breasts of different shapes and sizes wearing the underwear.

In one embodiment, the at least one elastic support component is strip-shaped and has a first part and a second part with different thicknesses.

In one embodiment, the elastic support component is bonded to a target object by hot press.

As mentioned above, the aided design method for female underwear of the present invention is to obtain various dynamic body parameters corresponding to the profile of female body by identifying and judging from the image associated with the profile of female body, and then to compare the dynamic body parameters with the content of the dynamic model database. Accordingly, an exclusive design of the underwear can be provided for the breasts in the image to obtain better dynamic support by using the elastic support component.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

FIGS. 1 and 2 are schematic diagrams showing the images of the recorded person in the running state according to an embodiment of the invention.

FIGS. 3 to 6 are the schematic diagrams showing the different elastic support component of the invention.

FIG. 7 is the flow chart of the aided design method for female underwear according to the embodiment of the invention.

FIG. 8 is the schematic diagram showing the robot device in order to analogize human motion according to the embodiment of the invention.

FIGS. 9 and 10 are the schematic diagrams showing the female underwear having the elastic support component according to the embodiment of the invention.

### DETAILED DESCRIPTION

In the following description, this invention will be explained with reference to embodiments thereof. However, the description of these embodiments is only for purposes of illustration rather than limitation.

The following will clearly illustrate the spirit of the invention with drawings and detailed descriptions. Anyone with ordinary skill in the art who understands the embodiments of the invention can make changes and modifications with the techniques taught in the invention, which does not deviate from the spirits and scope of the invention.

The language used herein is for the purpose of describing embodiments and is not intended to be limiting. The singular forms such as “a”, “the”, “this” and “these”, as used herein, also include the plural forms. As used herein, “and/or” includes any and all combinations of the stated objects. Directional terms used herein, such as up, down, left, right, front or rear, etc., are only to refer to the directions of the accompanying drawings. Therefore, the directional language used is for illustration and not for limitation of the invention.

Dynamic Model Database

In the embodiment, the dynamic model database is related to various information of the female body during exercise that may include breast width, nipple spacing, height of the lower edge of the breast, breast volume, chest width, chest length, shoulder width, height, weight, waist circumference, pelvic width, and other parameters, and further includes the relative positional relationship and related information between the shape of the breast and the sternum, ribs, shoulders, abdomen, and other parts during exercise.

The dynamic model database is an image database associated with shaking or swing of the female breast and the corresponding breast dynamic mathematical model. The mathematical model is the norm, which is composed of the track record of the fixed marker of the clavicle and abdomen during female exercise, and then the mathematical dynamic equation of the breast shaking during female exercise is established by numerical analysis tools. The dynamic model database includes a first dynamic model database and a second dynamic model database. The first dynamic model database stores dynamic data associated with a plurality of breasts of different shapes and sizes, and the second dynamic model database stores dynamic data associated with a plurality of breasts of different shapes and sizes wearing the underwear. In other words, the content of the first dynamic model database is the data associated with the naked women, and the content of the second dynamic model database is the data associated with the women wearing the underwear. Further, it can also be divided into different sub-databases according to the style of the underwear.

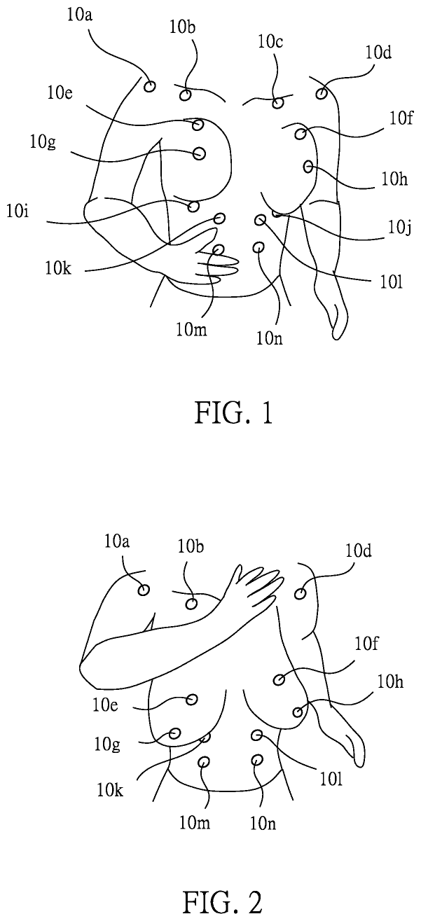

The content of the dynamic model database may be the images or data corresponding to breast shaking that are recorded by different real people, such as 3,000 people, when they perform walking, running, jumping, side shifting, or aerobic exercise in two states. The two states include the state of being naked and the state of wearing the underwear. As shown in FIG. 1 and FIG. 2, before recording, the markers 10a-10n or sensors can be set on the body of the recorded person, such as the sternum, ribs, clavicle, breast, shoulder, or abdomen, respectively, to record the relative position of each marker in the process of different exercises. In the part of the breast, the marker can also be set along the curve of the breast. FIG. 1 and FIG. 2 are images showing different times when the recorded person is running. It can be found that in the running activity of the recorded person, the relative positions of the markers 10a-10n are constantly changing. By recording the relative positional relationship of the markers 10a-10n, the software can further identify and analyze the positional change correlation between the markers, which can be further used as data for training artificial intelligence identification.

In addition, the dynamic model database may further include a third dynamic model database, which stores data associated with the relationship between the elastic support components of different types arranged at different positions and the inhibition of breast movement.

Elastic Support Component

In the embodiment, the elastic support component is a strip-shaped elastic film, which can also be called an elastic sticker that can be combined on the fabric of the underwear by hot pressing, welding, adhesive bonding, or other similar techniques. Here, the elastic support component is, for example, combined with the side of the female underwear that is far away from the human skin. In one embodiment, a supporting force can be provided by each elastic support component through its tension. In another embodiment, an integrated supporting force and a covering force can be provided by a plurality of elastic support components through its comprehensive tension. The so-called supporting force or covering force refers to the force used to stabilize the breast, which can provide dynamic support in addition to static support through the elastic support component to restrain the breast shaking caused by exercise.

The material of the elastic support component can be selected from silicon, polyurethane (PU), thermoplastic polyurethane (TPU), thermoplastic elastomer (TPE), and combinations thereof. In addition, the elastic support component can also be embedded in the fabric of the underwear. It should be noted, when the elastic support component is made of biocompatible material, it can also be set on the inner side of the underwear, that is, the side that can be in contact with human skin.

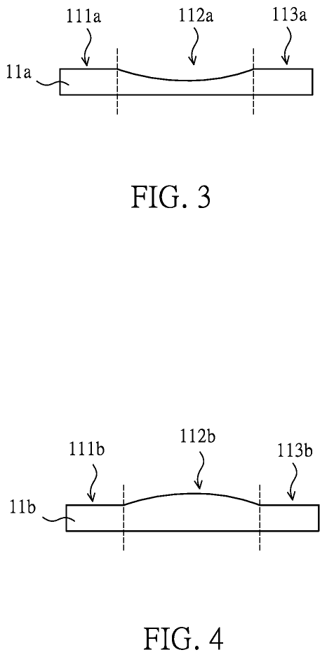

In the embodiment, a single elastic support component can have multiple different tensions, which means that the elastic support component can be divided into multiple segments. Please refer to FIGS. 3 to 6 to illustrate the structural types of the elastic support component with different tensions.

As shown in FIG. 3, the elastic support component 11a has a first part 111a, a second part 112a, and a third part 113a, wherein the second part 112a is positioned between the first part 111a and the third part 113a. In the embodiment, the thicknesses of the first part 111a and the third part 113a are greater than the thickness of the second part 112a, and the thickness of the second part 112a is a gradual change, that is, the thickness of the elastic support component 11a is thinner toward the center. Accordingly, the elastic support component 11a can provide greater tension in thicker sections through the difference in thickness.

As shown in FIG. 4, the elastic support component 11b has a first part 111b, a second part 112b, and a third part 113b, wherein the second part 112b is positioned between the first part 111b and the third part 113b. In the embodiment, the thicknesses of the first part 111b and the third part 113b are smaller than the thickness of the second part 112b, and the thickness of the second part 112b is gradually changed, that is, the thickness of the elastic support component 11b is thicker toward the center. Accordingly, the elastic support component 11b can provide greater tension in thicker sections through the difference in thickness.

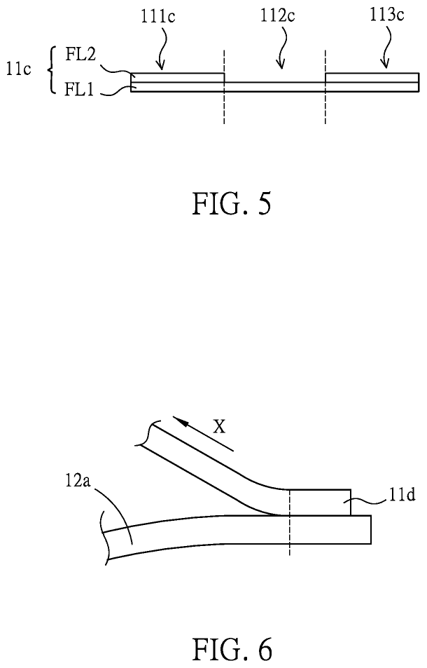

As shown in FIG. 5, the elastic support component 11c has a first part 111c, a second part 112c, and a third part 113c, wherein the second part 112c is positioned between the first part 111c and the third part 113c. In the embodiment, the elastic support component 11c has a first elastic film layer FL1 and a second elastic film layer FL2, wherein the second elastic film layer FL2 is stacked on the first elastic film layer FL1 by hot pressing or adhesive bonding. s shown in FIG. 5, the second elastic film layer FL2 is provided in the segments of the first part 111c and the third part 113c. Accordingly, the elastic support component 11c can provide greater tension in thicker sections through the difference in thickness.

As shown in FIG. 6, the elastic support component 11d provides a force along the X-direction to the elastic support component 11d in the process of being combined with a carrier 12a, so that the elastic support component 11d is stretched and deformed before combined with the carrier 12a. By controlling the force that provides the pre-tension, the elastic support component 11d can be made to have different tensions in different segments. For example, combining the elastic support component 11d and the carrier 12a while providing a larger pre-stretching force will make this segment have a larger tension. In other words, the strength of tension is related to the magnitude of the pre-tension force.

The above description about the elastic support component is mostly illustrated by dividing it into three segments, but it is not a limitation. The number of segments for the elastic support component can be any positive integer as required. In addition, the quantity, size, or type of the elastic support component combined with the carrier (the underwear) can also be selected according to actual needs. The skilled in the art can perform corresponding extension and derivation according to the content of the embodiments.

The First Embodiment of Aided Design Method

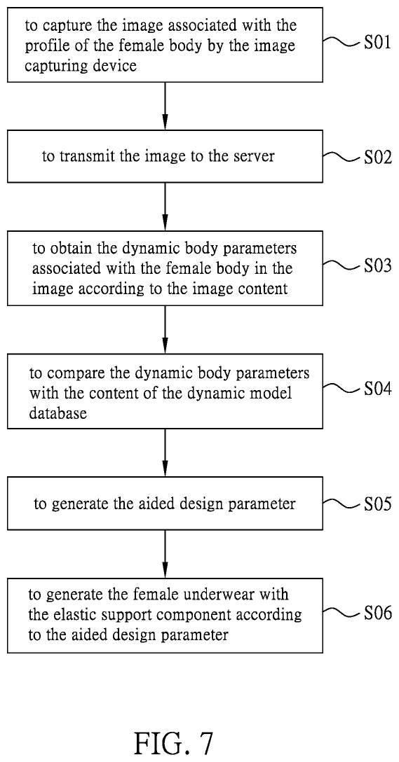

Please refer to FIG. 7, the aided design method for female underwear of the present invention includes steps S01 to S06. Step S01 is to capture an image associated with the profile of a female body by an image capturing device. Step S02 is to transmit the image to the server. Step S03 is to obtain a plurality of dynamic body parameters associated with the female body in the image according to the image content. Step S04 is to compare the dynamic body parameters with the content of the dynamic model database. Step S05 is to generate an aided design parameter according to the comparison result. Step S06 is to generate a female underwear with the elastic support component according to the aided design parameter. Three embodiments are presented below in conjunction with FIG. 7 to illustrate the implementation of the aided design method for female underwear of the present invention.

The first embodiment is to design the underwear that can provide better dynamic support through the aided design program of female underwear after the consumer takes a dynamic image such as a video.

Step S01 is to shoot a dynamic video of a naked female body with the image capturing device. The image capturing device is an electronic device with camera function such as a camera, a video camera, or a mobile phone. The scope of the female body at least includes the upper body covering the neck, shoulders, hands, chest, and abdomen, and it is better to include a complete body image. The dynamic video can include actions such as walking, running, jumping, or side-shifting, which can be in the same video file or in separate video files. In addition, the filmed videos may also include videos of the same action but shot from different angles.

Step S02 is to transmit the dynamic video to a server. The server is, for example, a cloud server, which can receive the transmitted video, has computing and storage capabilities, and can connect to a dynamic model database and access its content.

Step S03 is to identify or analyze the content of the dynamic video uploaded by the consumer to obtain a plurality of dynamic body parameters associated with the female body in the video. The dynamic body parameters are related to various information of the female body during exercise that may include breast width, nipple spacing, height of the lower edge of the breast, breast volume, chest width, chest length, breast height, shoulder width, height, weight, waist circumference, pelvic width, and the relative positional relationship and related information between the shape of the breast and the sternum, ribs, shoulders, abdomen, and other parts during exercise. Some of the information, such as height, weight, or waist circumference, can be input by consumer in addition to being obtained through identification or analysis.

Step S04 is to compare the aforementioned dynamic body parameters with the content of the dynamic model database. Since the video in the first embodiment is a naked female body, the dynamic body parameters are compared with the content of the aforementioned first dynamic model database.

Step S05 is to generate an aided design parameter according to the comparison result. The aided design parameter is the setting position, setting direction, shape, length, width, thickness, tensile strength, and combination thereof of at least one elastic support component on a female underwear.

Step S06 is to generate the female underwear with the elastic support component according to the aided design parameter. Among them, the style of female underwear can be selected by the aided design program, or a specific style selected by the consumer. It should be noted that when the style of the underwear is specified by the consumer, the aided design program will generate the best design of the underwear of the specified style according to the style of the underwear and the aided design parameter to provide the most suitable dynamic support for the breasts of the women in the dynamic video.

The Second Embodiment of Aided Design Method

The second embodiment is to design the underwear that can provide better dynamic support through the aided design program of female underwear after the consumer takes the static image.

Step S01 is to shoot a static image of a naked female body with the image capturing device. The image capturing device is an electronic device with camera function such as a camera, a video camera, or a mobile phone. The scope of the female body at least includes the upper body covering the neck, shoulders, hands, chest, and abdomen, and it is better to include a complete body image. The static image may include images of the female target photographed from different angles, which may include the image of the front side, left side, right side, top view, bottom view, rear side and various angles in between.

Step S02 is to transmit these static images to a server. The server is, for example, a cloud server, which has computing and storage capabilities, and can connect to the dynamic model database and access its content.

Step S03 is to identify, analyze, and integrate the content of the static image uploaded by the consumer to generate a simulated dynamic image. Among them, the simulated dynamic image is based on the static images to generate dynamic images corresponding to walking, running, jumping, or side shifting. The aforementioned dynamic body parameters associated with the female body in the image are obtained from the static images and/or the simulated dynamic image.

Step S04 is to compare the aforementioned dynamic body parameters with the content of the dynamic model database. Since the image in the second embodiment is a naked female body, the dynamic body parameters are compared with the content of the aforementioned first dynamic model database.

Step S05 is to generate an aided design parameter according to the comparison result. The aided design parameter is related to the setting position, setting direction, shape, length, width, thickness, tensile strength, and combination thereof of at least one elastic support component on the female underwear.

Step S06 is to generate the female underwear with the elastic support component according to the aided design parameter. Among them, the style of female underwear can be selected by the aided design program, or a specific style selected by the consumer. It should be noted that when the style of the underwear is specified by the consumer, the aided design program will generate the best design of the underwear of the specified style according to the style of the underwear and the aided design parameter to provide the most suitable dynamic support for the breasts of the women in the dynamic video.

The Third Embodiment of Aided Design Method

The third embodiment is that the designer of the underwear wears an underwear prototype on a robot device after designing the prototype of the underwear, then start the robot device and shoot dynamic images, and optimize and adjust the underwear prototype through the aided design program.

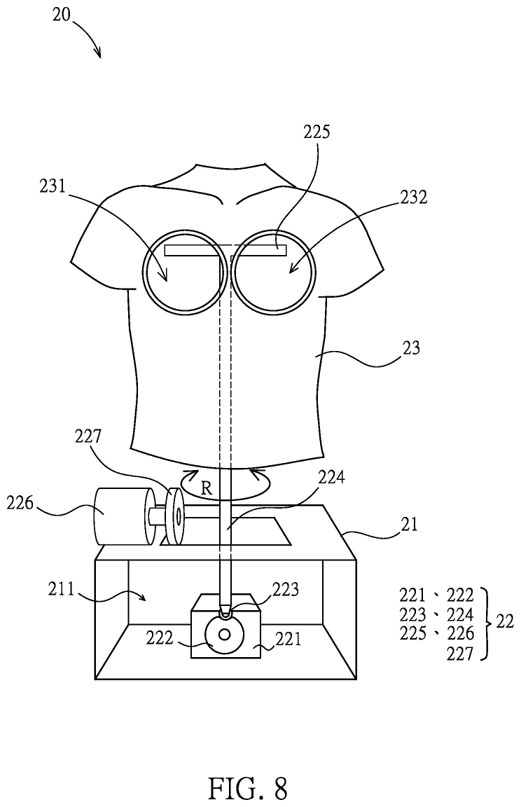

Please refer to FIG. 8, the robot device 20 is a kind of the robot device 20 capable of simulating human motion. The robot device 20 has a base 21, a driving unit 22, and a mannequin 23.

The base 21 can be composed of a plurality of brackets and/or a plurality of support plates that have an accommodation space 211. The driving unit 22 has a first motor 221, a cam 222, a roller 223, a connecting rod 224, a connection element 225, a second motor 226, and a guiding wheel 227. The first motor 221 is fixed to the base 21, the cam 222 is connected to the first motor 221, the roller 223 is connected to the cam 222 and also the connecting rod 224. The connecting rod 224 extends upward to the inside of the mannequin 23 and the connecting rod 224 is connected to the connection element 225 on one side relative to the roller 223. Among them, the connecting rod 224 and the connection element 225 are formed in a T-shape.

The mannequin 23 is connected with the connection element 225 or the connecting rod 224 and has two openings 231 and 232 at the position corresponding to the human chest, and the two openings 231 and 232 also correspond to the position of the connection element 225. The connection element 225 can connect the breast prostheses with different sizes and shapes (not shown in the figure) and extends to the outside of the mannequin 23 through the openings 231 and 232 to simulate human breasts. Breast prostheses can be made of materials such as silicone, latex, or water polo. It is available in various sizes of breast prostheses using the data from the dynamic model database.

The guiding wheel 227 is connected with the second motor 226 and is arranged between the base 21 and the mannequin 23, wherein the guiding wheel 227 is arranged relative to the bottom side of the mannequin 23. It is to be noted that the setting position of the guiding wheel 227 can be more inclined to a certain side of the mannequin 23, such as left side or right side. The number of guiding wheels 227 can also be increased according to actual needs (such as the fineness of the movements), for example, there are one guiding wheel 227 disposed on the left side and right side, respectively. When there are plural guide wheels 227, the matched motors do not need to be increased correspondingly. In other words, part of the guide wheel 227 may be rotated autonomously by the motor, and part of the guide wheel 227 may be rotated passively.

The first motor 221 can drive the cam 222 to rotate, and the rotation of the cam 222 can cause the roller 223 to change its position, thereby driving the connecting rod 224, the connection element 225, and the mannequin 23 to move up and down, that is to produce a smooth reciprocating (back and forth) motion in the follower. The second motor 226 is to drive the guiding wheel 227 to rotate. When the mannequin 23 touches the guiding wheel 227 during the up and down motion, it will make the mannequin 23 produce a motion similar to swing or rotation, showing a combination of up and down motion and/or swinging left and right along the rotating axis R within a range to simulate the dynamic behavior of the upper body of women during walking, running, jumping, and aerobic exercise.

Next, please refer to FIGS. 7 and 8, the first is to hang the breast prostheses on the mannequin 23 and wear the underwear designed by the designer on the mannequin 23. Then arranging the marker on the underwear including the profile of the underwear and sternum, ribs, collarbone, shoulders, or abdomen of the mannequin 23. After setting the marker, the motor is enabled to drive the mannequin 23. It is to be noted that the exercise mode of the mannequin 23 including walking, running, jumping, or cardio can be selected through a controller.

Step S01 is to shoot a dynamic video of the robot device with the image capturing device. The scope of the robot device includes at least the upper body covering the neck, shoulders, hands, chest, abdomen, and the complete body image is better.

Step S02 is to transmit the dynamic video to a server. The server is, for example, a cloud server, which can receive the transmitted video, has computing and storage capabilities, and can connect to the dynamic model database to access its content.

Step S03 is to identify or analyze the uploaded content of the dynamic video to obtain a plurality of dynamic body parameters associated with the female body in the video.

Step S04 is to compare the dynamic body parameters with the content of the dynamic model database. Since the video of the embodiment is associated with the female body wearing the underwear, the dynamic body parameters are compared with the content of the aforementioned second dynamic model database.

Step S05 is to generate an aided design parameter according to the comparison result. The aided design parameter is related to the setting position, setting direction, shape, length, width, thickness, tensile strength, and combination thereof of at least one elastic support component on the female underwear.

Step S06 is to generate a better design of the elastic support component on the underwear prototype according to the aided design parameter. If the elastic support component has been originally designed on the underwear prototype, the aided design program will be able to make adjustments on the basis of the original design to enhance its dynamic support effect and reduce the shaking of the breasts during exercise so as to protect the breasts without strained breast ligaments from shaking.

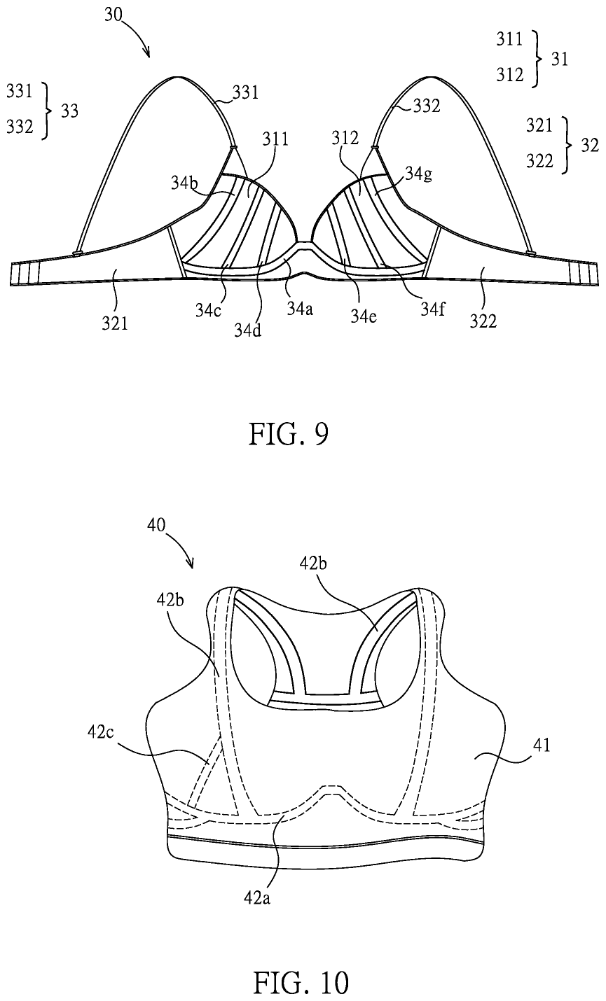

Please refer to FIG. 9 and FIG. 10, which are respectively the female underwear with the elastic support component generated by the aided design program, wherein, FIG. 9 is the traditional type of underwear and FIG. 10 is the sports type of underwear.

As shown in FIG. 9, the underwear 30 includes a cup part 31, a side wing part 32, a shoulder-strap part 33, and a plurality of elastic support components 34a-34g. The cup part 31, the side wing part 32, and the shoulder-strap part 33 are all symmetrically arranged, that is, the cup part 31 has a first cup 311 and a second cup 312, the side wing part 32 has a first side wing 321 and a second side wing 322, and the shoulder-strap part 33 has a first shoulder-strap 331 and a second shoulder-strap 332. The first cup 311 and the second cup 312 are arranged adjacently, the first shoulder-strap 331 is connected to the first cup 311 and the first side wing 321, and the second shoulder-strap 332 is connected to the second cup 312 and the second side wing 322, thereby forming the underwear 30. The elastic support component 34a is arranged on the lower edge of the cup part 31, the elastic support components 34b-34d are arranged on the first cup 311, and the elastic support components 34e-34g are arranged on the second cup 312. The elastic support component 34a is to provide a supporting force to the breast bottom of wearer. One side of the elastic support components 34b-34g may be connected to the elastic support component 34a and extend in a direction away from the elastic support component 34a. Accordingly, the elastic support components 34a-34g can provide better holding and covering ability when the wearer is exercising and can avoid lymphatic parts to avoid lymphatic compression due to the design being more flexible.

As shown in FIG. 10, the underwear 40 is a sports type underwear, which has an underwear body 41 and a plurality of elastic support components 42a-42c. The elastic support component 42a is arranged corresponding to the lower edge of the breast of wearers that can extend to both sides or back of the body and the elastic support components 42b are respectively extended upward (i.e., corresponding to the direction of the shoulders of wearers) to the rear side from the elastic support components 42a.

It is to be noted that there are many reasons for the difference in size and shape of the left and right breasts, such as congenital or surgical. In this case, the difference can be identified in the images received by the server or the aided design program to give a better design respectively. As shown in FIG. 10, it is assumed that the size of the right breast of the wearer is larger than that of the left breast, so the elastic support component 42c can be provided on the underwear 40 to strengthen the dynamic restraint design of holding and covering of the right breast.

The above-mentioned arrangement of the elastic support component is only an example rather than a limitation. The design parameters, including setting position, setting direction, shape, length, width, thickness, and tensile strength, will be adjusted according to different body structures and breast conditions.

As mentioned above, the aided design method for female underwear of the present invention is to obtain various dynamic body parameters corresponding to the profile of female body by identifying and judging from the image associated with the profile of female body, and then to compare the dynamic body parameters with the content of the dynamic model database. According to this, an exclusive design of the underwear can be provided for the breasts in the image to obtain better dynamic support through the elastic support component. Accordingly, an exclusive design of the underwear can be provided for the breasts in the image to obtain better dynamic support by using the elastic support component. In other words, the elastic support component can adjust the strength and direction of the support force, according to this, for different breast shapes and sizes, the weight of the breast can be guided through the elastic support component to be supported by the latissimus dorsi and fascicularis to reduce the burden on the shoulders and neck and avoid the compression of the axillary lymph glands. The present invention improves various problems caused by the traditional fixing methods of using underwires to fix the breasts or flattening the breasts, and also reduces the complicated procedures such as repeated measurement, pattern making, try-on, and reinforcement.

Even though numerous characteristics and advantages of certain inventive embodiments have been set out in the foregoing description, together with details of the structures and functions of the embodiments, the disclosure is illustrative only. Changes may be made in detail, especially in matters of arrangement of parts, within the principles of the present disclosure to the full extent indicated by the broad general meaning of the terms in which the appended claims are expressed.

What is claimed is:

1. An aided design method for female underwear, comprising:
receiving at least one image associated with a profile of a female body;
obtaining a plurality of dynamic body parameters associated with the female body according to the at least one image;
comparing the dynamic body parameters with a content of a dynamic model database; and
generating an aided design parameter according to the comparison result, wherein the aided design parameter is a setting position, setting direction, shape, length, width, thickness, tensile strength, and combination thereof associated with at least one elastic support component disposed on a female underwear.

2. The aided design method of claim 1, wherein the at least one image includes a plurality of static images or at least one dynamic image.

3. The aided design method of claim 2, wherein the static images include at least two images from at least two different angles and a simulated dynamic image being generated according to the static images.

4. The aided design method of claim 2, wherein the dynamic images include images of walking, running, jumping, side shifting, and combinations thereof.

5. The aided design method of claim 1, wherein the profile corresponding to the female body in the at least one image includes a plurality of markers, which are respectively arranged at positions corresponding to the sternum, ribs, breasts, shoulders and/or abdomen.

6. The aided design method of claim 1, wherein a subject of the at least one image is a robot device capable of simulating human motion.

7. The aided design method of claim 1, wherein the dynamic model database includes a first dynamic model database and/or a second dynamic model database, wherein the first dynamic model database stores dynamic data associated with a plurality of breasts of different shapes and sizes and the second dynamic model database stores dynamic data associated with a plurality of breasts of different shapes and sizes wearing the underwear.

8. The aided design method of claim 1, wherein the at least one elastic support component is strip-shaped and has a first part and a second part with different thicknesses.

9. The aided design method of claim 1, wherein the elastic support component is bonded to a target object by hot press.
